(19) United States
(12) Patent Application Publication
(10) Pub. No.: US 2025/0035302 A1
(43) Pub. Date: Jan. 30, 2025

(54) Heat Exchanger Element and Use Thereof

(71) Applicant: ANDRITZ Technology and Asset Management GmbH, Graz (AT)

(72) Inventor: Klaus Stanke, Baienfurt (DE)

(21) Appl. No.: 18/711,157

(22) PCT Filed: Nov. 3, 2022
(86) PCT No.: PCT/EP2022/080725

§ 371 Date: May 17, 2024

(30) Foreign Application Priority Data
Dec. 9, 2021 (AT) A50982/2021

(51) Int. Cl. F22B 31/00; F22B 31/08

(52) U.S. Cl. CPC F22B 31/0023; F22B 31/08

(57) ABSTRACT

A heat transfer element comprising an inlet, an outlet, vertical heat exchanger tubes, a lower collector and an upper distributor. A vertical riser pipe is arranged between the inlet and the upper distributor. This minimizes thermal stress in the heat exchanger element in the application.

### BACKGROUND

The disclosed embodiments relate to a fluidized bed with a heat exchanger comprising a fluidized bed wall, wherein the heat exchanger comprises at least one heat exchanger element and the heat exchanger element further comprises a horizontal inlet, a horizontal outlet, vertical heat exchanger tubes, a lower horizontal collector, wherein the vertical heat exchanger tubes are connected at their lower end to the lower collector and the lower collector is connected to the outlet, an upper horizontal distributor, wherein the vertical heat exchanger tubes are connected at their upper end to the upper distributor and the upper distributor is connected to the inlet. The embodiments also relate to a use of the disclosed heat exchanger element.

Various heat exchangers have proven to be particularly suitable for use in fluidized beds, such as horizontal coil heat exchangers, plate heat exchangers and heat exchangers with vertical tubes. Heat exchangers with vertical tubes, for example, are characterized by good accessibility and cleanability, especially when operating with steam as the heat transfer medium. Steam is introduced into the heat exchanger through an inlet at the top section of the heat exchanger and the mixture of steam and condensate is removed through an outlet at the bottom of the heat exchanger.

Typically, the heat exchanger is placed in a fluidized bed, with the inlet and outlet passing through the wall of the fluidized bed. For example, a heat exchanger with vertical tubes is shown in FIG. 1 of AT 405 685 B. State-of-the-art heat exchangers allow efficient transport of condensate in the direction of gravity but are limited in height due to strength and stress considerations. A higher overall height can be achieved by using an alternative design, such as the horizontal coil heat exchanger, or by suspending the vertical tubes of the heat exchanger. Such a suspended arrangement is shown, for example, in FIG. 1 of DE 32 33 959 A1.

WO 2012 163 961 discloses a steam generator with steam boilers which have riser pipes. The steam boiler comprises a heat exchanger, whereby feed water is supplied to the heat exchanger via a feed water supply in the lower part of the heat exchanger. The feed water rises in the pipes of the heat exchanger and is added to the riser pipe at the top. A drain valve is located at the bottom of a connecting pipe that is connected to the riser pipe and can be used to drain the system.

### SUMMARY

Provided herein is a heat exchanger or a heat exchanger element which achieves improved condensate transport in the direction of gravity and/or improved drainage behaviour, but which is not limited in height.

This is achieved in the disclosed embodiments by arranging a vertical riser pipe between the inlet and the upper distributor, wherein the riser pipe connects the inlet and the upper distributor and wherein the riser pipe is configured such that the inlet is arranged closer to the outlet than to the upper distributor, wherein the inlet and the outlet are passed through the fluidized bed wall and the riser pipe, the upper distributor, the lower collector and the vertical heat exchanger tubes are arranged within the fluidized bed wall. The outlet, lower collector and the lower ends of the heat exchanger tubes are arranged below the inlet, upper distributor and the upper ends of the heat exchanger tubes. A heat transfer medium, e.g. steam, is supplied to the heat exchanger element via the inlet, whereby the heat transfer medium is supplied to the upper distributor through the riser pipe. The heat transfer through the riser pipe is comparatively negligible, as the riser pipe has a relatively small surface area compared to the large number of heat exchanger tubes. The heat transfer medium is distributed from the upper distributor to the heat exchanger tubes and flows downwards through them.

Any condensation or condensate that occurs is advantageously transported downwards by gravity to the lower collector, which is beneficial in terms of the pressure drop that occurs in the heat exchanger element. The heat transfer medium or any condensate is discharged through the outlet. As the outlet and inlet typically pass through a wall surrounding the heat exchanger element, whereby the riser pipe allows the outlet and inlet to be placed closer to each other, i.e., the inlet in particular is closer to the outlet than to the upper distributor, the stress load on the heat exchanger element can be effectively reduced. The distance between the inlet and outlet is particularly important for the stress load due to the different thermal expansions of the surrounding wall and heat exchanger element. The disclosed heat exchanger element thus makes it possible to realise significantly greater heights compared to the state of the art. In summary, the disclosed embodiments synergistically allow an advantageous pressure drop or drainage behaviour as well as an advantageous stress load on the heat transfer element.

Advantageously, the lower collector and the upper distributor of the heat exchanger element are configured as a tube. The tube design is particularly easy and inexpensive to realise. Advantageously, the lower collector and the upper distributor are arranged horizontally, which is advantageous in terms of the pressure drop that occurs, particularly when condensation occurs.

It is also preferable to implement reinforcing elements, e.g. U-shaped sleeves or caps for protection against abrasion, in the connection area of the upper distributor and the vertical heat exchanger tubes. The connection between the upper distributor and the vertical heat exchanger tubes is made by welding or soldering, for example. The use of reinforcing elements in the sensitive connection area can protect this area from abrasion.

It is also advantageous to realise a heat exchanger element with a ratio of the hydraulic diameter of the upper distributor to the hydraulic diameter of one of the heat exchanger tubes of less than 2.5 and preferably less than 1.5. If several heat exchanger elements are combined to form one heat exchanger and in order to obtain heat exchangers with the highest possible packing density, it is important that the individual heat exchanger elements have sufficiently slim dimensions. This is made possible by an advantageous dimensioning of the upper distributor, whereby the hydraulic diameter is to be formed as the quotient of the area through which the flow passes and the circumference of the area through which the flow passes.

An advantageous design is characterised in that flow elements, e.g. throttles, orifices, valves, flaps, etc., are placed between the upper distributor and the vertical heat exchanger tubes to influence the flow through the heat exchanger tubes. The heat transfer medium is supplied to the heat exchanger tubes via the upper distributor, whereby the distribution of the heat transfer medium follows the pressure distribution in the upper distributor. In order to achieve the most uniform and therefore optimum distribution to the individual heat exchanger tubes, it is advantageous to place flow elements between the upper distributor and the heat exchanger tubes, which have a levelling effect on the local pressure or flow rate.

As disclosed herein, at least one heat exchanger element forms a heat exchanger for a fluidised bed dryer, wherein particularly preferably two or more heat exchanger elements also form the heat exchanger. The heat exchanger elements can be arranged parallel to each other. Particularly in fluidised bed applications, this results in less fouling on the heat exchanger than, for example, in heat exchangers with horizontal coils.

The inventive embodiments comprise a fluidised bed with a fluidised bed wall and a heat exchanger with heat exchanger elements, wherein the inlet and outlet pass through the fluidised bed wall, the vertical heat exchanger tubes are arranged vertically, i.e. perpendicularly, and the riser pipe, the upper distributor, the lower collector, and the vertical heat exchanger tubes are arranged within the fluidised bed wall. The effect results from the routing of the inlet and outlet through the wall and the arrangement of the riser pipe in the fluidised bed, whereby the riser pipe connects the inlet and the upper distributor and whereby the riser pipe is designed such that the inlet is arranged closer to the outlet than to the upper distributor.

Also disclosed is a use of a heat exchanger in a fluidised bed with steam as the heat transfer medium. Especially with condensing media—such as steam—the heat exchanger disclosed herein has advantages such as low pressure drop and optimum drainage behaviour.

### BRIEF DESCRIPTION OF THE DRAWINGS

The invention will now be described using the examples in the drawing.

FIG. 1 shows a heat exchanger element according to the disclosure.

### DETAILED DESCRIPTION

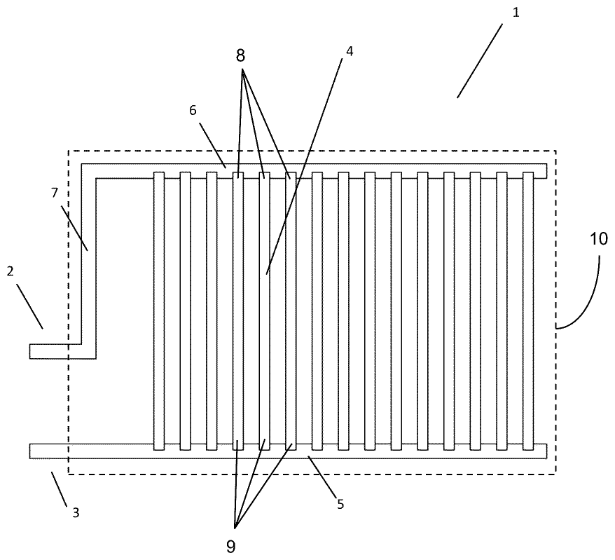

FIG. 1 shows a heat exchanger element 1 with an inlet 2, an outlet 3, vertical heat exchanger tubes 4, a lower collector 5, wherein the vertical heat exchanger tubes 4 are connected at their respective lower ends 9 to the lower collector 5 and the lower collector 5 is connected to the outlet 3, an upper distributor 6, wherein the vertical heat exchanger tubes 4 are connected at their respective upper ends 8 to the upper distributor 6 and the upper distributor 6 is connected to the inlet 2. It is also shown that a vertical riser pipe 7 is arranged between the inlet 2 and the upper distributor 6, wherein the riser pipe 7 connects the inlet 2 and the upper distributor 6 and wherein the riser pipe 7 is designed in such a way that the inlet 2 is arranged closer to the outlet 3 than to the upper distributor 6.

As shown, the inlet 2 and the outlet 3 pass through a fluidized bed wall 10 and the riser pipe 7, the upper distributor 6, the lower collector 5 and the vertical heat exchanger tubes 4 are arranged within the fluidized bed wall 10.

The present invention offers numerous advantages. The heat exchanger element disclosed herein effectively reduces the stress on the heat exchanger element and allows greater overall heights to be realized. At the same time, the heat exchanger element allows an advantageous pressure drop and optimum drainage behaviour.

1-7. (canceled)

8. A fluidized bed, comprising:
a heat exchanger comprising:
a fluidized bed wall,
at least one heat exchanger element (1) with a horizontal inlet (2), a horizontal outlet (3), multiple vertical heat exchanger tubes (4), a lower horizontal collector (5), and an upper horizontal distributor (6), wherein
each of the vertical heat exchanger tubes (4) extends from a respective upper end (8) to a respective lower end (9) with the respective lower ends of the vertical heat exchanger tubes (4) connected to the lower collector (5) and the respective upper ends of the heat exchanger tubes (4) connected to the upper distributor (6),
the lower collector (5) is connected to the outlet (3),
the upper distributor (6) is connected to the inlet (2), further comprising
a vertical riser pipe (7) arranged between the inlet (2) and the upper distributor (6) and connecting the inlet (2) and upper distributor (6) to one another, wherein
the riser pipe (7) is configured such that the inlet (2) is positioned closer to the outlet (3) than to the upper distributor (6),
the inlet (2) and the outlet (3) are guided through the fluidized bed wall, and
the riser pipe (7), the upper distributor (6), the lower collector (5) and the vertical heat exchanger tubes (4) are arranged within the fluidized bed wall.

9. The fluidized bed according to claim 8, wherein each of the lower collector (5) and the upper distributor (6) is configured as a horizontal tube.

10. The fluidized bed according to claim 8, further comprising reinforcing elements implemented in a connecting region of the upper distributor (6) and the vertical heat exchanger tubes (4).

11. The fluidized bed according to claim 10, wherein the reinforcing elements comprise caps having a U-shape configured for protection against abrasion.

12. The fluidized bed according to claim 10, wherein the upper distributor (6) has a first hydraulic diameter and one or more of the heat exchanger tubes (4) has a second hydraulic diameter and the ratio of the first hydraulic diameter to second hydraulic diameter is less than 2.5.

13. The fluidized bed according to claim 8, wherein the upper distributor (6) has a first hydraulic diameter and one or more of the heat exchanger tubes (4) has a second hydraulic diameter and the ratio of the first hydraulic diameter to second hydraulic diameter is less than 2.5.

14. The fluidized bed according to claim 13, wherein the ratio of the first hydraulic diameter to second hydraulic diameter is less than 1.5.

15. The fluidized bed according to claim 9, wherein the upper distributor (6) has a first hydraulic diameter and one or more of the heat exchanger tubes (4) has a second hydraulic diameter and the ratio of the first hydraulic diameter to second hydraulic diameter is less than 2.5.

16. The fluidized bed according to claim 8, further comprising flow elements for influencing the flow through the heat exchanger tubes (4) arranged between the upper distributor (6) and the vertical heat exchanger tubes (4).

17. The fluidized bed according to claim 9, further comprising flow elements for influencing the flow through the heat exchanger tubes (4) arranged between the upper distributor (6) and the vertical heat exchanger tubes (4).

18. The fluidized bed according to claim 16, wherein the flow elements comprise one or more of throttles and orifices.

19. The fluidized bed according to claim 8, wherein the at least one heat exchanger element (1) comprises two or more heat exchanger elements (1) arranged parallel to one another.

20. The fluidized bed according to claim 9, wherein the at least one heat exchanger element (1) comprises two or more heat exchanger elements (1) arranged parallel to one another.

21. The fluidized bed according to claim 13, wherein the at least one heat exchanger element (1) comprises two or more heat exchanger elements (1) arranged parallel to one another.

22. A method of using of a heat exchanger in a fluidized bed, comprising:
providing and operating a fluidized bed according to claim 8, wherein steam is a heat transfer medium.
